(19) United States
(12) Patent Application Publication
(10) Pub. No.: US 2011/0147196 A1
(43) Pub. Date: Jun. 23, 2011

(54) Recovery of propane purge stream from a propylene oxide production process

(75) Inventor: Kimberly A. Petry, Friendswood, TX (US)

(73) Assignee: Lyondell Chemical Technology, L.P., Greenville, DE (US)

(21) Appl. No.: 12/655,099

(22) Filed: Dec. 23, 2009

(51) Int. Cl. B01D 3/14

(52) U.S. Cl. 203/81

(57) ABSTRACT

A process for recovering a purified propane purge comprising fractionating in a first distillation column a feed stream comprising 2 to 10 wt % methanol, 5 to 20 wt % propylene, and 70 to 90 wt % propane thereby producing a first light product stream and a first heavy product stream, the first heavy product stream comprising less than 1.5 wt % propylene, and an amount of methanol that is at least 70 wt % of the methanol present in the first distillation column feed stream; and fractionating the first heavy product stream in a second distillation column at a pressure from 220 to 258 psia, thereby producing a second light product stream and a second heavy product stream, the second light product stream comprising at least 96 wt % propane and less than 1 wt. % methanol, and wherein an amount of propane present in the second light product stream is 20 to 45 wt % of the propane present in the first distillation column feed stream.

### FIELD OF THE INVENTION

The present invention relates generally to a process for recovering propane from a stream containing propylene, propane and methanol. More particularly, the present invention relates to a process for recovering a purified propane stream as a purge from a propylene oxide production process.

### BACKGROUND OF THE INVENTION

Reaction of olefins with hydrogen peroxide in the presence of a catalyst is known. U.S. Pat. No. 6,646,141 describes such a process where a reaction product containing propylene, propane, propylene oxide, methanol and water is treated to separate the various components by pre-evaporation, followed by partial condensation. In such a way, a light product of propylene, propane, propylene oxide, methanol and water, and a heavier stream containing propylene oxide, water and methanol is formed. Propylene oxide is recovered from the heavier stream, and uncondensed material, containing propylene and propane, is compressed and distilled.

Reaction of olefins, hydrogen and oxygen in the presence of a catalyst to form an epoxide is known, as described for example in U.S. Pat. No. 7,138,535. In the so-called direct propylene oxide process, oxygen, hydrogen and propylene are reacted in a slurry of catalyst particles and solvent(s), such as methanol and water. In such a process, a propane-containing ballast gas can be used to maintain reaction pressure. Byproducts such as propane, propylene glycol methyl ethers (PGME), and propylene glycols can be formed in the reaction process. Propane is formed by the hydrogenation of propylene. PGME are formed by the reaction of propylene oxide with methanol. Glycols are formed by the reaction of propylene oxide with water

Separation and recycle of the methanol, unreacted propylene and propane gas from the propylene oxide present in the reaction product is desirable, however, because propane is continually generated as a byproduct in the reaction process, this component needs to be purged from the reaction system to maintain material balance. Preferably, the purged propane stream should be of sufficient purity to allow it to be sold or used internally as a chemical feedstock. Alternately, if the propane-rich stream is to be used in a fuel gas system, it is desirable that the stream be “dry,” i.e., having a minimal content of methanol. Complicating the separation of such streams containing propane, propylene and methanol, however, is the methanol-propane azeotrope, preventing adequate separation of the components. It has unexpectedly been found that by using two distillation steps, one of which is below the methanol-propane azeotrope, it is possible to separate propane from methanol and propylene in an economical way, to allow the purge of a purified propane stream from a propylene oxide production process.

### SUMMARY OF THE INVENTION

The present invention relates to a process for recovering a purified propane purge stream comprising fractionating in a first distillation column a feed stream comprising 2 to 10 wt % methanol, 5 to 20 wt % propylene, and 70 to 90 wt % propane. The first distillation column feed stream is separated into a first light product stream and a first heavy product stream, the first heavy product stream comprising less than 1.5 wt % propylene, and an amount of methanol that is at least 70 wt % of the methanol present in the first distillation column feed stream. The first heavy product stream is then fractionated in a second distillation column at a pressure from 220 to 258 psia, thereby separating the first heavy product stream into a second light product stream and a second heavy product stream. The second light product stream comprises at least 96 wt % propane and less than 1 wt % methanol. The amount of propane present in the second light product stream is 20 to 45 wt % of the propane present in the first distillation column feed stream.

### BRIEF DESCRIPTION OF THE DRAWINGS

FIG. 1 is a process flow diagram of the first and second distillation columns and associated equipment.

FIG. 2 is a process flow diagram of the feed treatment for the first and second distillation columns.

### DETAILED DESCRIPTION OF THE INVENTION

The invention is a process for recovering a purified propane stream from a feed stream containing propylene, propane, and methanol. The feed stream is preferably generated in a propylene oxide production process, more preferably in a process involving the direct contact of oxygen, hydrogen and propylene in a slurry containing catalyst and a solvent. In this direct propylene oxide process, a ballast gas containing saturated hydrocarbons with 1-4 carbon atoms, e.g., methane, ethane, propane, and n-butane is utilized to maintain desired reaction operating pressures. The reaction product is subjected to a separation process to produce a propylene oxide-containing stream and a propylene oxide-depleted stream containing propylene, methanol, propylene oxide, byproducts, and ballast gas

While the propane in the propylene oxide-depleted stream can be recycled back to the propylene oxide reaction process for use as ballast gas, because propane is continually produced as a byproduct in the reaction process, some propane must be is continuously purged from the propylene oxide production system to remain in material balance. To provide flexibility in the disposition of the purged propane, it is desirable that the propane be of sufficient purity to permit its use as a feedstock in other processes utilizing propane as a chemical feedstock. Alternately, if the purged stream is to be routed to a plant fuel gas system, it is desirable to produce a dry (minimal methanol) propane stream.

To recover the propane purge stream, the propylene oxide-depleted stream first undergoes a series of compression-cooling steps, with the resulting liquid and vapor phases then being separated. A propane-rich stream resulting from the compression-cooling steps is then passed to a first distillation column. It is preferred to feed a liquid stream to the first distillation column because it minimizes the light end vapor material in the column overhead and allows for the use of a non-refrigerated reflux condenser. In the first distillation column, feed is separated into a first light product stream and a first heavy product stream. The first light product stream is enriched in propylene, and the first heavy product stream is enriched in propane and methanol.

The first light product stream is totally or partially condensed, with the non-condensed material either being recycled to the propylene oxide reaction process, further processed in downstream equipment for additional component recovery or passed to a plant fuel gas system. The condensed material is recycled to the propylene oxide reactors.

The first heavy product stream is passed to a second distillation column, where the separation is conducted at a pressure below the propane-methanol azeotrope. The second distillation column separates the first heavy product stream into a second light product stream and a second heavy product stream. The second heavy product stream is enriched in methanol. The second light product stream, enriched in propane, can be used as feedstock in a chemical plant or passed to the plant fuel gas system.

### First Distillation Column

The first distillation column preferably operates at a pressure from 320 to 380 psia to allow the use of a liquid feed stream, which minimizes light ends recovery and permits the use of a non-refrigerated reflux condenser. One skilled in the art would recognize that column operating temperatures are determined by the processed stream compositions and operating pressure. The first distillation column generally has at least from 33 to 68 theoretical stages, although one skilled in the art would recognize that additional stages can be used if desired, to reduce energy costs.

The first distillation column can be fabricated from any materials consistent with the associated operating conditions and the characteristics of the materials processed.

Similarly, the tower trays and separation media can be of any type that is used for such separation processes. The first distillation column is equipped with a reflux condenser and a reboiler. The reboiler provides heat input to the column and increases the temperature and/or vaporizes higher boiling material in the tower. The reboiler can be of any design consistent with the overall configuration of the column. The reboiler preferably utilizes steam as the heating medium, and typically has a duty of 750 to 1300 Btu/lb-feed. The reflux condenser removes heat from the column and condenses lower boiling material in the tower. The reflux condenser can be either a total or partial condenser, and preferably uses water as its cooling medium. Condenser duty is typically 720 to 1300 Btu/lb-feed. One skilled in the art would recognize that energy utilizations for both the condenser and reboiler can vary with the number of theoretical stages in the column.

Feed to the first distillation column comprises 2 to 10 wt %, more preferably 2.5 to 8 wt % methanol; 5 to 20 wt %, more preferably 8 to 18 wt % propylene, and 70 to 90 wt %, more preferably 73 to 88 wt % propane, and optionally up to 5 wt % of minor components selected from water, propylene oxide, oxygen, methane, ethane, and inerts such as nitrogen and carbon dioxide, and mixtures thereof. When the minor components are present, the total amount of any individual minor component is preferably less than 2 wt %. Preferably, when propylene oxide is present in the feed, it is present in an amount less than 0.2 wt %, more preferably less than 0.15 wt %.

The first distillation column separates the feed into a first lower boiling light product stream and a first higher boiling heavy product stream. For the purposes of this specification, the term light product stream means the flow of lower boiling material exiting the column downstream of the reflux condenser that is not returned to the is column as reflux. The term lights stream means the total flow of lower boiling material exiting the column upstream of the reflux condenser. The term heavy product stream means the flow of higher boiling material exiting the column that is not returned to the column through the reboiler. The term heavy stream means the total flow of higher boiling material exiting the column upstream of the reboiler.

The first heavy product stream is enriched in propane and methanol, with lower levels of propylene, propylene oxide, and is preferably 30 to 46 wt % of the feed. The first heavy product stream contains less than 1.5 wt %, preferably less than 1.0 wt %, more preferably less than 0.6 wt % propylene; preferably from 90.5 to 93.5 wt %, more preferably 91 to 93 wt % propane; and preferably from 6 to 9 wt %, more preferably 6.5 to 8.5 wt % methanol. When present in the first distillation column feed, propylene oxide is preferably present in the first heavy product stream at a concentration of less than 0.35 wt %, more preferably less than 0.3 wt %. The amount of methanol exiting the column in the first heavy product stream on a mass flow basis (e.g., lb/hr), is at least 70 wt % of the methanol entering the column in the column feed, preferably at least 75 wt %.

The first lights stream comprises propane and propylene, and methane, ethane, oxygen, methanol, water and inerts if present in the column feed, and is preferably 54 to 70 wt % of the feed. Preferably, the first light product stream contains 0.8 to 4 wt %, more preferably 1.1 to 3.5 wt % ethane; 10 to 35 wt %, more preferably 12 to 34 wt % propylene; 57 to 87 wt %, more preferably 59 to 86 wt % propane, and 0.1 to 1.1 wt %, more preferably 0.1 to 1.0 wt % methanol, with the remainder being inerts, oxygen, methane and water. The first light product stream may be partially or totally condensed, with the non-condensed stream containing primarily propane and lighter components, with lower levels of methanol and water. Preferably, the non-condensed material in the light product stream is routed to a fuel gas system. The condensed material is either routed to other separation equipment for further processing or returned to the propylene oxide production process.

The ratio of the column reflux stream to the distillate flow (reflux ratio) of the first distillation column is preferably 7.5 to 15 but can be varied to improve component separation up to tower flooding limitations.

### Second Distillation Column

The second distillation column operates at from 220 to 258 psia, preferably 230 to 250 psia. Such pressure ranges are below the methanol-propane azeotrope, but high enough that the reflux condenser can operate with water as the cooling medium. One skilled in the art would recognize that the operating temperatures of the second distillation column would be determined by the column composition and the column operating pressure.

The second distillation column typically has at least 20 to 33 theoretical stages, although one skilled in the art would recognize that additional stages can be used if desired, to reduce energy costs. The second distillation column can be fabricated from any materials consistent with the associated operating conditions and the characteristics of the materials processed. Similarly, the tower trays and/or separation media can be any that are used for such separation processes. The second distillation column is equipped with an reflux condenser and a reboiler. The reboiler provides heat input to the column and increases the temperature and/or vaporizes higher boiling material in the column. The reboiler can be of any design consistent with the overall configuration of the column. The reboiler preferably utilizes steam as the heating medium, and typically has a duty of 330 to 480 Btu/lb-feed. The reflux condenser removes heat from the column and condenses lighter boiling material in the tower. The reflux condenser can be either a total or partial condenser, and preferably uses water as its cooling medium. Condenser duty is typically 350 to 500 Btu/lb-feed. One skilled the art would recognize that energy utilizations for both the condenser and reboiler can vary with the number of theoretical stages in the column.

Feed to the second distillation column is the heavy product stream from the first distillation column. The second distillation column separates the feed into a second lower boiling light product stream and a second higher boiling heavy product stream. The heavy product stream is preferably 15 to 35 wt % of the feed and preferably contains propylene in an amount less than 0.25 wt %, preferably less than 0.2 wt %; propane in an amount from 58 to 78, more preferably 61 to 76 wt %; propylene oxide in an amount from 0.3 to 0.9, more preferably 0.4 to 0.8 wt %; and methanol in an amount from 20 to 40, more preferably 23 to 37 wt %.

The second light product stream is preferably 65 to 85 wt % of the feed, and contains less than 1 wt % methanol, preferably less than 0.8 wt % and more preferably less than 0.7 wt %; less than 1 wt % propylene, more preferably less than 0.9 wt %, most preferably less than 0.75 wt %. The propane concentration of the second light product stream is at least 96 wt %, preferably at least 98 wt %. The amount of propane present in the second light product stream is 20 to 45 wt %, preferably, 22 to 43 wt % of the propane present in the first distillation column feed stream, on a mass flow basis (e.g., lb/hr). Operation of the first and second distillation columns can be adjusted as necessary within these percentages to maintain the overall propane balance on the propylene oxide production process.

The lights stream from the second distillation column may be partially or totally condensed, with the condensed material either being passed to the plant gas system or sold as a chemical plant feedstock.

The second distillation column typically operates at a reflux ratio of 3 to 4.5, but can be increased as necessary to further improve overhead product purities, up to the tower flooding limits.

### Distillation Column Feed Treatment

Preferably, feed to the first distillation column is routed from a process for the production of propylene oxide, more preferably, a process for production of propylene oxide involving the reaction of propylene and oxygen in the so-called direct propylene oxide process, where propylene, oxygen and hydrogen are contacted in a reactor containing a slurry composed of catalyst suspended in solvent. A ballast gas containing propane is utilized in the reactor to maintain reactor pressure. Propylene oxide produced in the reactor is recovered from the reaction product in a separation process that produces a propylene oxide-containing stream, and a propylene oxide-depleted stream. In addition to the feed components to the first distillation tower described above, the propylene-oxide depleted stream can contain PMGE.

The propylene oxide-depleted stream is subjected to a series of compression-cooling steps to partially separate propane and propylene from methanol and water, where the final pressure of the propylene oxide-depleted stream is raised to between 320 and 380 psia. After each step, the two-phase, cooled, compressed stream is separated into liquid and vapor phases, with the vapor passed to a compressor to further increase the pressure of the material. After separation of the liquid phase resulting from the final compression-cooling step, a portion of the liquid is routed to the distillation columns for recovery of the propane purge stream.

The following modeled examples are merely illustrative. Those skilled in the art will recognize many variations that are within the spirit of the invention and scope of the claims.

### Example 1

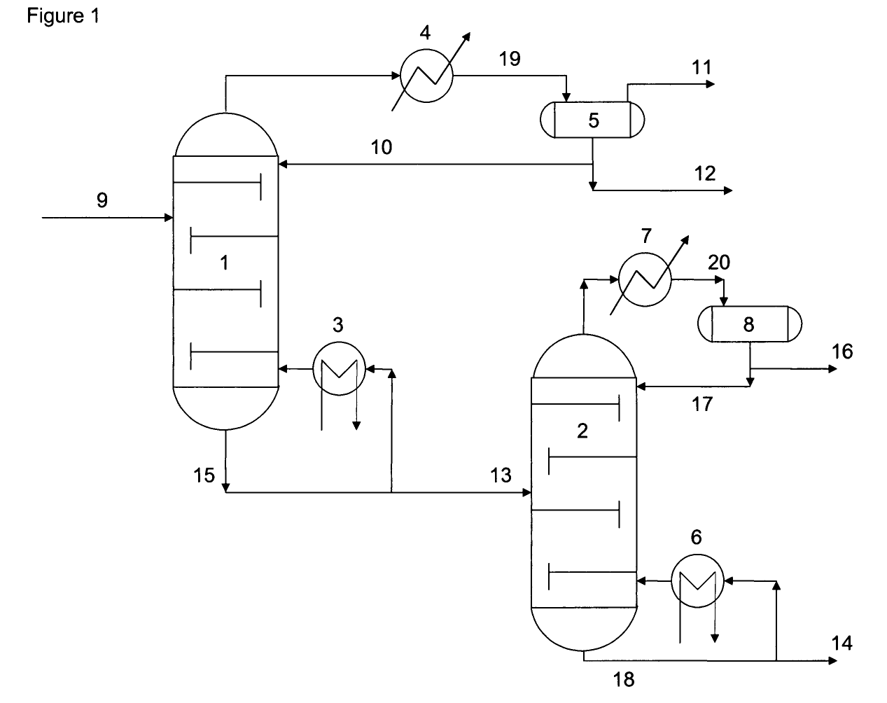

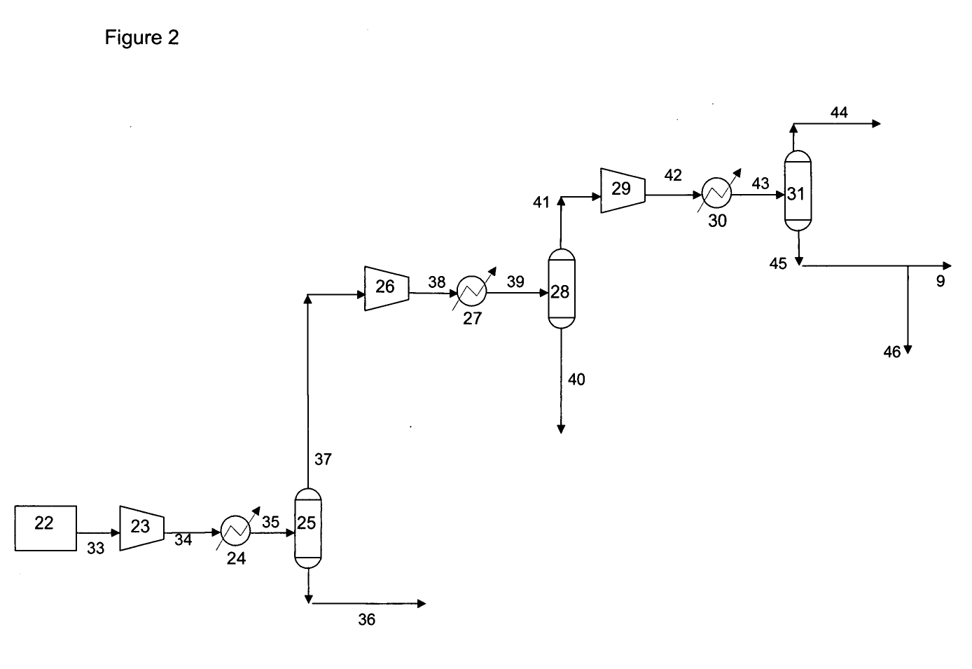

The propane purge stream is recovered by the process shown in FIGS. 1 and 2.

A stream from a direct propylene oxide production process 22 is passed via line 33 at 117° F. and 27 psia to a first compressor 23, where the stream is compressed to 75 psia and 221° F. The resultant compressed stream is passed via line 34 to a heat exchanger 24 where the compressed stream is cooled to 120° F. and 70 psia. The cooled stream is then passed via line 35 to a first flash drum 25, where the cooled stream is separated into a first flashed liquid stream and a first flashed vapor stream.

The first flashed liquid stream is passed via line 36 back to the propylene oxide production process. The first flashed vapor stream is passed via line 37 to a second compressor 26 where the vapor stream is compressed to 190 psia and 220° F. The resultant compressed stream is passed via line 38 to a heat exchanger 27 and cooled to 120° F. and 185 psia. The cooled stream is passed via line 39 to a second flash drum 28, where the cooled stream is separated into a second flashed liquid stream and a second flashed vapor stream.

The second flashed liquid is passed via line 40 back to the propylene oxide production process. The first flashed vapor stream is passed via line 41 to a third compressor 29 where the vapor stream is compressed to 385 psia and 200° F. The resultant compressed stream is passed via line 42 to a heat exchanger 30 where the compressed stream is cooled to 120° F. and 380 psia. The cooled stream is then passed via line 43 to a third flash drum 31, where the cooled stream is separated into a third flashed liquid stream and a third flashed vapor stream.

The third flashed vapor stream is passed via line 44 back to the propylene oxide production process. The third flashed liquid stream is split, with a portion being passed via line 46 back to the propylene oxide production process and the remainder to the first distillation column via line 9.

First distillation column 1 contains 68 theoretical stages (not including the condenser and reboiler), with the feed entering the column at stage 29. The pressure drop across first distillation column 1 is 8 psi. In the first distillation column 1, the feed stream is separated into a light product stream and a heavy product stream. The overhead temperature of first distillation column 1 is 132° F., and the bottoms temperature is 147° F. The lights stream of first distillation column 1 is partially condensed in condenser 4 to a temperature of 105° F., and the resultant stream passed to accumulator drum 5 via line 19. Non-condensed material exits accumulator drum 5 via line 11. Condensed material is either passed to first distillation column 1 as reflux via line 10, or exits the process as light product via line 12. The reflux ratio of the first distillation column 1 is 9.3. The heat duty of condenser 4 is −33×10⁶ btu/hr and the heat duty of the reboiler 3 is 35×10⁶ btu/hr. The first distillation column heavy stream exits the column via line 15, and either passes through reboiler 3 as it is returned to the column, or is fed to the second distillation column 2.

The heavy product stream is fed to the second distillation column 2 at 147° F. and 328 psia via line 13. Second distillation column 2 operates at a pressure of 250 psia, and contains 33 theoretical stages (not including the condenser and reboiler), with the feed entering at stage 27. The pressure drop across the second distillation column 2 is 7 psi. The overhead temperature of the second distillation column is 122° F. and the bottoms temperature is 125° F. The lights stream of the second distillation column is condensed in condenser 7, and the resultant stream passed to accumulator 8 via line 20. Condensed material is either returned to second distillation column 2 as reflux via line 17, or exits the process as light product of the second distillation column, via line 16. The reflux ratio of the second distillation column is 3.3. The heat duty of condenser 7 is −7×10⁶ btu/hr, and the heat duty of reboiler 6 is 7×10⁶ btu/hr. The second distillation column heavy stream exits the column via line 18, and either passes through reboiler 6 is as it is returned to the column, or exits the process as heavy product via line 14.

The material balance of various streams of Example 1 is shown in Tables 1A/B.

TABLE 1A
Example 1

| Com- | Stream 9 | | Stream 13 | | Stream 11 | | Stream 12 | | Stream 16 | | Stream 14 | |
|---|---|---|---|---|---|---|---|---|---|---|---|---|
| ponent | wt % | lbs/hr | wt % | lbs/hr | wt % | lbs/hr | wt % | lbs/hr | wt % | lbs/hr | wt % | lbs/hr |
| O₂ | 0.22 | 99 | — | — | 1.26 | 89 | 0.05 | 9 | — | — | — | — |
| CH₄ | 1.38 | 614 | — | — | 7.08 | 502 | 0.64 | 112 | — | — | — | — |
| Inerts | 1.13 | 506 | — | — | 4.94 | 350 | 0.90 | 156 | — | — | — | — |
| C₂H₆ | 0.82 | 365 | — | — | 2.29 | 162 | 1.17 | 202 | — | — | — | — |
| C₃H₆ | 17.99 | 7,997 | 0.50 | 100 | 31.27 | 2,217 | 32.83 | 5,679 | 0.65 | 91 | 0.14 | 9 |
| Propane | 74.59 | 33,143 | 91.42 | 18,326 | 52.83 | 3,745 | 64.00 | 11,071 | 98.84 | 13,745 | 74.62 | 4,581 |
| PO | 0.10 | 44 | 0.22 | 44 | — | — | — | — | — | — | 0.72 | 44 |
| MEOH | 3.65 | 1,624 | 7.84 | 1,573 | 0.10 | 7 | 0.25 | 43 | 0.50 | 69 | 24.49 | 1,503 |
| Water | 0.08 | 37 | — | — | 0.19 | 14 | 0.13 | 23 | — | — | — | — |
| Totals | | 44,429 | | 20,043 | | 7,086 | | 17,295 | | 13,905 | | 6,137 |

TABLE 1B
Example 1

| Com- | Stream 33 | | Stream 36 | | Stream 37 | | Stream 40 | | Stream 41 | | Stream 44 | | Stream 45 | | Stream 46 | |
|---|---|---|---|---|---|---|---|---|---|---|---|---|---|---|---|---|
| ponent | wt % | lbs/hr | wt % | lbs/hr | wt % | lbs/hr | Wt % | lbs/hr | wt % | lbs/hr | wt % | lbs/hr | wt % | lbs/hr | wt % | lbs/hr |
| O₂ | 0.52 | 685 | — | — | 0.57 | 685 | — | — | 0.60 | 684 | 1.99 | 486 | 0.22 | 198 | 0.22 | 99 |
| CH₄ | 2.44 | 3226 | — | — | 2.69 | 3225 | — | — | 2.84 | 3222 | 8.16 | 1993 | 1.38 | 1228 | 1.38 | 614 |
| Inerts | 1.48 | 1966 | — | — | 1.64 | 1961 | 0.13 | 8 | 1.72 | 1952 | 3.84 | 940 | 1.13 | 1012 | 1.13 | 506 |
| C₂H₆ | 0.86 | 1139 | — | — | 0.95 | 1137 | 0.06 | 3 | 1.00 | 1134 | 1.65 | 403 | 0.82 | 730 | 0.82 | 365 |
| C₃H₆ | 15.65 | 20658 | 0.95 | 117 | 17.17 | 20541 | 2.95 | 186 | 17.96 | 20354 | 17.85 | 4360 | 17.99 | 15994 | 17.99 | 7997 |
| Propane | 63.14 | 83353 | 4.71 | 584 | 69.20 | 82769 | 10.80 | 681 | 72.46 | 82087 | 64.70 | 15801 | 74.59 | 66286 | 74.59 | 33143 |
| PO | 0.10 | 132 | 0.14 | 17 | 0.09 | 115 | 0.32 | 20 | 0.08 | 94 | 0.02 | 5 | 0.10 | 88 | 0.10 | 44 |
| MEOH | 14.41 | 19029 | 82.70 | 10257 | 7.33 | 8772 | 80.85 | 5101 | 3.24 | 3671 | 1.72 | 422 | 3.65 | 3248 | 3.65 | 1624 |
| Water | 1.30 | 1720 | 10.80 | 1340 | 0.31 | 379 | 4.70 | 296 | 0.07 | 83 | 0.03 | 8 | 0.08 | 74 | 0.08 | 37 |
| PGME | 0.06 | 80 | 0.60 | 80 | — | — | — | — | — | — | — | — | — | — | — | — |
| Totals | | 131,988 | | 12,395 | | 119,584 | | 6,295 | | 113,281 | | 24,418 | | 88,858 | | 44,429 |

### Example 2

A feed stream 9, at 120° F. and 380 psia is passed via line 9 to a first distillation column 1 operating at an overhead pressure of 320 psia. First distillation column 1 contains 33 theoretical stages (not including the condenser and reboiler), with the feed entering the column at stage 13. The pressure drop across first distillation column 1 is 7 psi. In the first distillation column 1, the feed stream is separated into a light product stream and a heavy product stream. The overhead temperature of first distillation column 1 is 138° F., and the bottoms temperature is 147° F. The lights stream of first distillation column 1 is partially condensed in condenser 4 to a temperature of 110° F., and the resultant stream passed to accumulator drum 5 via line 19. Non-condensed material exits accumulator drum 5 via line 11. Condensed material is either passed to first distillation column 1 as reflux via line 10, or exits the process as light product via line 12. The reflux ratio of the first distillation column is 8.0. The heat duty of condenser 4 is −44×10⁶ btu/hr, and of the heat duty of the reboiler 3 is 44×10⁶ btu/hr. The first distillation heavy stream exits the column via line 15, and either passes through reboiler 3 as it is returned to the column, or is fed to the second distillation column 2.

The heavy stream is fed to the second distillation column 2 at 147° F. and 327 psia via line 13. Second distillation column 2 operates at a pressure of 250 psia, and contains 20 theoretical stages (not including the condenser and reboiler), with the feed entering the column at stage 14. The pressure drop across the second distillation column 2 is 6 psi. The overhead temperature of the second distillation column is 122° F. and the bottoms temperature is 127° F. In the second distillation column 2, the heavy product from the first distillation column 1 is separated into a lights stream and a heavy product stream. The lights stream of the second distillation column is condensed in condenser 7, and the resultant stream passed to accumulator 8 via line 20. Condensed material is either returned to second distillation column 2 as reflux via line 17, or exits the process as light product of the second distillation column, via line 16. The reflux ratio of the second distillation column is 4.0. The heat duty of condenser 7 is −8×10⁶ btu/hr, and the heat duty of the reboiler is 8×10⁶ btu/hr. The second distillation column bottoms exits the column via line 18, and either passes through reboiler 6 as it is returned to the column, or exits the process as heavy product via line 14.

The material balance of various streams of Example 2 is shown in Table 2.

TABLE 2
Example 2

| Com- | Stream 9 | | Stream 13 | | Stream 11 | | Stream 12 | | Stream 16 | | Stream 14 | |
|---|---|---|---|---|---|---|---|---|---|---|---|---|
| ponent | wt % | lbs/hr | wt % | lbs/hr | wt % | lbs/hr | Wt % | lbs/hr | wt % | lbs/hr | wt % | lbs/hr |
| O₂ | 0.13 | 70 | — | — | 4.70 | 0.2 | 0.19 | 70 | — | — | — | — |
| CH₄ | — | 0.1 | — | — | 2.36 | 0.1 | — | — | — | — | — | — |
| Inerts | — | 0.2 | — | — | 4.25 | 0.2 | — | — | — | — | — | — |
| C₂H₆ | 1.89 | 996 | — | — | 5.67 | 0.2 | 2.75 | 995 | — | — | — | — |
| C₃H₆ | 8.09 | 4,258 | 0.51 | 85 | 11.35 | 0.4 | 11.55 | 4,172 | 0.63 | 81 | 0.09 | 3 |
| Propane | 86.61 | 45,555 | 91.27 | 15,041 | 70.93 | 2.7 | 84.48 | 30,512 | 98.76 | 12,784 | 63.85 | 2,256 |
| PO | 0.03 | 20 | 0.12 | 20 | — | — | — | — | — | — | 0.57 | 20 |
| MEOH | 3.15 | 1,661 | 8.07 | 1,330 | 0.50 | 0.0 | 0.91 | 330 | 0.60 | 78 | 35.45 | 1,252 |
| Water | 0.06 | 33 | — | — | 0.21 | 0.0 | 0.09 | 33 | — | — | — | — |
| Totals | | 52,593 | | 16,476 | | 3.8 | | 36,112 | | 12,943 | | 3,531 |

### Example 3

A feed stream 9, at 120° F. and 380 psia is passed via line 9 to a first distillation column 1 operating at an overhead pressure of 320 psia. First distillation column 1 contains 33 theoretical stages (not including the condenser and reboiler), with the feed entering the column at stage 13. The pressure drop across first distillation column 1 is 7 psi. In the first distillation column 1, the feed stream is separated into a light product stream and a heavy product stream. The overhead temperature of first distillation to column 1 is 138° F., and the bottoms temperature is 146° F. The lights stream of first distillation column 1 is partially condensed in condenser 4 to a temperature of 110° F., and the resultant stream passed to accumulator drum 5 via line 19. Non-condensed material exits accumulator drum 5 via line 11. Condensed material is either passed to first distillation column 1 as reflux via line 10, or exits the process as light product via line 12. The reflux ratio of the first distillation column is 15.0. The heat duty of condenser 4 is −68×10⁶ btu/hr, and of reboiler 3 is 68×10⁶ btu/hr. The first distillation column heavy stream exits the column via line 15, and either passes through reboiler 3 as it is returned to the column, as feed to the second distillation column 2.

The heavy product stream is fed to the second distillation column 2 at 146° F. and 327 psia via line 13. Second distillation column 2 operates at a pressure of 250 psia, and contains 20 theoretical stages (not including the condenser and reboiler), with the feed entering the column at stage 14. The pressure drop across the second distillation column 2 is 6 psi. The overhead temperature of the second distillation column is 122° F. and the bottoms temperature is 127° F. In the second distillation column 2, the heavy product stream from the first distillation column 1 is separated into a light product stream and a heavy product stream. The lights stream of the second distillation column is condensed in condenser 7, and the resultant stream passed to accumulator 8 via line 20. Condensed material is either returned to second distillation column 2 as reflux via line 17, or exits the process as light product of the second distillation column, via line 16. The reflux ratio of the second distillation column is 4.0. The heat duty of condenser 7 is −10×10⁶ btu/hr, and the heat duty of the reboiler is 10×10⁶ btu/hr. The second distillation column heavy stream exits the column via line 18, and either passes through reboiler 6 as it is returned to the column, or exits the process as bottoms product via line 14.

The material balance of various streams of Example 3 is shown in Table 3.

TABLE 3
Example 3

| Com- | Stream 9 | | Stream 13 | | Stream 11 | | Stream 12 | | Stream 16 | | Stream 14 | |
|---|---|---|---|---|---|---|---|---|---|---|---|---|
| ponent | wt % | lbs/hr | wt % | lbs/hr | wt % | lbs/hr | wt % | Lbs/hr | wt % | lbs/hr | wt % | lbs/hr |
| O₂ | 0.13 | 70 | — | — | 5.25 | 0.3 | 0.22 | 70 | — | — | — | — |
| CH₄ | — | 0.1 | — | — | 1.93 | 0.1 | — | — | — | — | — | — |
| Inerts | — | 0.2 | — | — | 3.50 | 0.2 | — | — | — | — | — | — |
| C₂H₆ | 1.89 | 996 | — | — | 6.44 | 0.3 | 3.13 | 996 | — | — | — | — |
| C₃H₆ | 8.09 | 4,258 | 0.40 | 85 | 12.90 | 0.6 | 13.14 | 4,172 | 0.49 | 81 | 0.07 | 3 |
| Propane | 86.61 | 45,555 | 92.79 | 19,356 | 69.27 | 3.5 | 82.54 | 26,196 | 98.92 | 16,452 | 68.69 | 2,903 |
| PO | 0.03 | 20 | 0.09 | 20 | — | — | — | — | — | — | 0.47 | 20 |
| MEOH | 3.15 | 1,661 | 6.69 | 1,395 | 0.46 | | 0.83 | 266 | 0.58 | 97 | 30.72 | 1,298 |
| Water | 0.06 | 33 | — | — | 0.21 | | 0.10 | 33 | — | — | — | — |
| Totals | | 52,593 | | 20,856 | | 5.0 | | 31,733 | | 16,630 | | 4,224 |

I claim:

1. A process for recovering a purified propane purge stream comprising:
fractionating in a first distillation column a feed stream comprising:
2 to 10 wt % methanol;
5 to 20 wt % propylene; and
70 to 90 wt % propane;
to separate the feed stream into a first light product stream and a first heavy product stream, the first heavy product stream comprising less than 1.5 wt % propylene, and an amount of methanol that is at least 70 wt % of the methanol present in the first distillation column feed stream; and
fractionating the first heavy product stream in a second distillation column at a pressure from 220 to 258 psia to separate the first heavy product stream into a second light product stream and a second heavy product stream, the second light product stream comprising at least 96 wt % propane and less than 1 wt % methanol, and wherein an amount of propane present in the second light product stream is 20 to 45 wt % of the propane present in the first distillation column feed stream.

2. The process of claim 1 wherein the propylene concentration in the first heavy product stream is less than 1.0 wt %.

3. The process of claim 2 wherein the propylene concentration in the first heavy product stream is less than 0.6 wt %.

4. The process of claim 1 wherein the methanol concentration of the second light product stream is less than 0.8 wt %.

5. The process of claim 4 wherein the methanol concentration of the second light product stream is less than 0.7 wt %.

6. The process of claim 1 wherein the second light product stream has a propylene concentration less than 1.0 wt %.

7. The process of claim 6 wherein the propylene concentration of the second light product stream is less than 0.9 wt %.

8. The process of claim 7 wherein the propylene concentration of the second light product stream is less than 0.75 wt %.

9. The process of claim 1 wherein the propane concentration of the second light product stream is at least 98 wt %.

10. The process of claim 1 wherein the amount of propane present in the second light product stream is 22 to 43 wt % of the propane present in the first distillation column feed stream.

11. The process of claim 1 wherein the pressure of the second distillation column is from 230 to 250 psia.

12. The process of claim 1 wherein the first distillation column feed stream comprises 8 to 18 wt % propylene.

13. The process of claim 1 wherein the first distillation column feed stream comprises 2.5 to 5 wt % of methanol.

14. The process of claim 1 wherein the first distillation column feed stream comprises 73 to 88 wt % propane.

15. The process of claim 1, wherein the first distillation column feed stream is produced in a propylene oxide production process.

16. The process of claim 15, wherein the propylene oxide production process is a direct propylene oxide production process.
